(19) United States
(12) Patent Application Publication
(10) Pub. No.: US 2026/0319531 A1
(43) Pub. Date: Oct. 15, 2026

(54) METHOD FOR OPERATING A PROCESS SYSTEM FOR PRESSURE CUSHION CONTROL OR FILLING LEVEL CONTROL IN A TANK, AND PROCESS SYSTEM

(71) Applicant: Buerkert Werke GmbH & Co. KG, Ingelfingen (DE)

(72) Inventors: Julian HEGMANN, Ingelfingen (DE); Tobias Kurz, Ingelfingen (DE); Klaus Beck, Ingelfingen (DE)

(21) Appl. No.: 19/646,720

(22) Filed: Apr. 14, 2026

(30) Foreign Application Priority Data
Apr. 15, 2025 (EP) 25170702

(51) Int. Cl. G05D 16/20; G05D 9/12

(52) U.S. Cl. CPC G05D 16/2033; G05D 9/12

(57) ABSTRACT

A method for operating a process system for pressure cushion or filling level control in a tank is specified, in which a fluid is contained, including a controller for setting a reference variable, wherein the controller includes a P-element, via which a proportional component of a control variable of the controller is set, and an I-element, via which an integral component of the control variable of the controller is set. The process system is operated selectively in a first, proportional operating mode or in a second, integral operating mode. The I-element of the controller makes no contribution to the control variable of the controller when the process system is operated in the second, integral operating mode, and the I-element of the controller makes a contribution to the control variable of the controller when the process system is operated in the first, proportional operating mode. Furthermore, a process system is described.

### FIELD OF THE DISCLOSURE

Embodiments of the present disclosure relate to a method for operating a process system for pressure cushion control or filling level control in a tank in which a fluid, for example a liquid and/or a gas, is contained. Furthermore, the invention relates to a process system.

### BACKGROUND

When controlling industrial processes using pressure cushion control or filling level control, different operating modes may occur. For example, pressure cushion control or filling level control may be performed with continuous fluid withdrawal, which corresponds to a proportional process type. Alternatively, pressure cushion control or filling level control may be performed without continuous withdrawal, which corresponds to an integral process type.

In a proportional process type, the best control performance can be achieved with a PID controller, whereas in an integral process type, the best control performance can be achieved with a PD controller.

In process systems where both operating modes are provided, i.e., pressure cushion control or filling level control with continuous withdrawal, and pressure cushion control or filling level control without continuous withdrawal, that controller is typically used which is compatible with that operating mode that is most frequently active or for which better control performance is desired. For the other operating mode, reduced control performance is accepted.

However, it is desirable to achieve optimal control performance for both operating modes. In this respect, the object of the present invention is to provide an optimized method for operating a process system for pressure cushion control or filling level control, and an optimized process system.

### SUMMARY

According to the present disclosure, the object is achieved by a method for operating a process system for pressure cushion control or filling level control in a tank in which a fluid, for example a liquid and/or a gas, is contained, comprising a controller for setting a reference variable, in particular a pressure of a pressure cushion in the tank or a filling level of a fluid contained in the tank, for example a liquid or a gas. The controller includes at least a P-element, via which a proportional component of a control variable of the controller is set, and an I-element, via which an integral component of the control variable of the controller is set. The process system is operated selectively in a first, proportional operating mode or in a second, integral operating mode. The I-element of the controller makes no contribution to the control variable of the controller when the process system is operated in the second, integral operating mode, and the I-element of the controller makes a contribution to the control variable of the controller when the process system is operated in the first, proportional operating mode.

For example, the I-element of the controller can be selectively switched on or off, so that the I-element of the controller makes a contribution to the control variable of the controller or makes no contribution thereto. The controller thus acts like a PID controller when the I-element is switched on, and like a PD controller when the I-element is switched off. The proportional component (P-element) of the controller ensures that the system can respond quickly to deviations from the setpoint variable, while the integral component (I-element) contributes to eliminate persistent deviations (permanent control deviations).

The method according to the present disclosure offers the advantage that the control behavior is optimized by always setting the control structure best suited to the respective operating mode, so that the best possible control performance is achieved. In other words, it allows for flexible response to varying process conditions.

Specifically, overshoot of the control signal during adjustment is avoided, and the desired level can be corrected without any control deviation when fluid is withdrawn from or supplied to the tank.

The I-element is switched on or off automatically, for example.

When the I-element is switched on, the controller responds not only to current deviations but also to accumulated deviations over time to correct persistent control deviations.

Cases of the present disclosure include, for example, so-called tank blanketing, in which a gas blanket (often nitrogen) is maintained over a (different) fluid, such as a liquid, in a closed tank, or the control of a filling level in a closed or open tank, for example in watering tanks in large-scale nurseries. However, other cases of application are also conceivable, such as a case of application in which a tank contains only gas and the gas pressure in the tank is controlled.

According to one aspect, in the first, proportional operating mode, fluid is withdrawn from the tank or supplied to the tank while the reference variable is kept constant by the control, and in the second, integral operating mode, no fluid is withdrawn from the tank. Control of the reference variable in the proportional operating mode ensures the stabilization of the control parameters, particularly the pressure or filling level, during withdrawal. This ensures that the process is not impaired by fluctuations in pressure or filling level.

In the first operating mode, for example, the pressure of the pressure cushion in the tank is kept constant by the control during fluid withdrawal, and in the second operating mode, the pressure of the pressure cushion in the tank is controlled while maintaining a constant filling level, in particular wherein a pressure level is changed in the second operating mode. A constant pressure of the pressure cushion during fluid withdrawal is essential to ensure a controlled withdrawal process. Maintaining a constant pressure despite fluid withdrawal ensures that processes remain stable and predictable. In the second operating mode, changes in the pressure level at a constant filling level allow the conditions inside the tank to be optimally adapted to subsequent processes.

A change in the pressure level in the second operating mode occurs, for example, during tank blanketing, when the pressure level is adjusted for different batches.

In pure filling level control for watering tanks, the tank is open, so that only the filling level is controlled and not the pressure inside the tank.

The tank may be provided with an inlet valve and a drain valve, or a combined inlet and drain valve may be present to remove fluid, particularly liquid, from the tank or to supply fluid, particularly liquid, to the tank, wherein the current operating mode can be determined based on a switching state and/or an opening state of the at least one valve, i.e., whether fluid is currently withdrawn or supplied, and the I-element of the controller is driven based on the determined operating mode.

The combined inlet and drain valve is a valve which functions simultaneously as an inlet and a drain valve.

In the case of a combined inlet and drain valve, the valve is, for example, a 3/3-way valve which operates against hydrostatic pressure during filling. In the case of separate inlet and drain valves, these are, for example, designed as 2/2-way valves.

By reading out the switching state or opening state of the at least one valve, it is particularly easy to determine whether withdrawal or supply of fluid, for example, withdrawal or supply of liquid, is currently taking place. More specifically, direct and reliable detection of the current operating mode is possible without additional sensors. The probability of misinterpretations or delays in detecting the operating mode is thus low. The absence of additional sensors also reduces the complexity of the system architecture.

When the at least one inlet and/or drain valve is open, the controller detects that the first operating mode is active, and the I-element provides an integral component to the control variable. If the at least one inlet and/or drain valve is closed, the controller detects that the second operating mode is active, and the I-element does not provide an integral component to the control variable. The control structure is thus dynamically adapted to the current process situation, particularly in real time, thus optimizing control performance.

According to one aspect, the controller receives a switching state and/or an opening state of the inlet valve and the drain valve or the combined inlet and drain valve as an input variable. By receiving immediate information about the valve state, the controller can react particularly quickly to changes in the system. This improves the dynamic performance of the system and ensures that setpoint values are efficiently reached and maintained. This reduces the risk of control errors due to faulty data.

Based on the detected operating mode, a binary signal is for example generated which represents the respective current operating mode and based on which the I-element of the controller is controlled. The direct control of the I-element of the controller based on a simple binary signal simplifies the control technology. In addition, binary signals carry only a very low risk of interpretation errors.

The tank may be a closed tank, and the pressure of the pressure cushion within the tank may be set by means of at least one control valve, wherein based on the control variable of the controller, which comprises the opening state of the at least one control valve, and additionally based on a control deviation, a current operating mode of the process system can be automatically detected, and the I-element of the controller is controlled according to the detected operating mode. The control variable of the controller corresponds to the output signal of the controller.

The automatic detection of the current operating mode based on the opening state of the at least one control valve and the control deviation enables continuous monitoring of the process system, allowing for an optimal response to changes. By determining an operating mode based on the control variable of the controller and additionally based on the control deviation of the at least one control valve, a separate switching input on the controller for detecting a state of the inlet and/or drain valve can be dispensed with. This means that no signal line from the inlet and drain valve to the controller is required, either. The process system can thus be manufactured particularly easily and cost-effectively.

For example, a single control valve in the form of a 3/3-way valve is provided, or two 2/2-way valves are provided.

According to a further embodiment, a filling level in the tank can be set, wherein based on the control variable of the controller, which comprises the opening state of the inlet valve and the drain valve or the combined inlet and drain valve, in other words, based on the output signal of the controller, and additionally based on a control deviation, a current operating mode of the process system is automatically detected, and the I-element of the controller is controlled according to the detected operating mode. This embodiment is also suitable for pure filling level control without pressure cushion control, in particular for open tanks.

The controller switches over, for example, more precisely, the controller activates the integral component when the control variable of the controller remains constant over a defined period of time and, in addition, when there is a persistent control deviation, for example over a period of at least one second, in particular over a period of at least ten seconds. In this case, the control deviation is, in particular, non-zero. In an exemplary embodiment, switching occurs when the control deviation is non-zero and remains constant over a period of at least ten seconds.

A persistent control deviation over a defined period of time indicates that the system may control incorrectly on a permanent basis. By automatically activating the integral component, the controller can correct such deviations. As previously explained, this increases control performance.

According to one aspect, an actual value of the pressure in the tank is detected by a pressure sensor, and a control deviation is calculated as the difference between the actual value and the setpoint value of the pressure. Calculating the control deviation as the difference between the actual value and the setpoint value allows the controller to respond immediately to deviations. This contributes to the ability of the system to respond quickly and effectively to changes or disturbances in the process. By continuously detecting the control deviation, the controller can dynamically adjust its strategy to maximize the efficiency of pressure control.

For example, the controller executes an algorithm to determine the current operating mode based on the control variable of the controller and a control deviation. The use of an algorithm enables automated and precise determination of the current operating mode in real time. This reduces the need for manual intervention and minimizes human errors by controlling the process in a data-driven manner. Consequently, the use of an algorithm improves the overall performance of the system.

For example, at least one parameter for the I-element is changed when the controller switches from the first, proportional operating mode to the second, integral operating mode, or vice versa.

Specifically, the adjusting time is changed to set the integral component of the controller. The adjusting time determines how strongly the integral component of a controller responds to control deviations. The shorter the adjusting time, the stronger the effect of the I-element.

If the I-element of the controller is not intended to make a contribution to the control variable of the controller, the adjusting time is set to infinity. The I-element is thus effectively switched off and therefore inactive.

If the adjusting time is less than infinity, the I-element is activated and consequently makes a contribution to the control variable.

The respective specific value for the adjusting time when the I-element is active depends on the desired process dynamics and is determined and set by the user.

The process described above, according to which the I-element is switched on or off, thus specifically means that switching takes place between an adjusting time of infinity and an adjusting time value specified by the user.

The object is further achieved according to the invention by a process system, in particular for carrying out a method according to the invention, comprising a tank in which a fluid, for example a liquid and/or a gas, is contained, and a controller for setting a reference variable, in particular the pressure of a pressure cushion in the tank or a filling level of a fluid contained in the tank, wherein the controller includes at least a P-element, via which a proportional component of a control variable of the controller is set, and an I-element, via which an integral component of the control variable of the controller is set. The process system is adapted to be operated selectively in a first, proportional operating mode or in a second, integral operating mode. The controller is configured to detect whether the process system is operated in the proportional operating mode or in the integral operating mode, and, when the process system is operated in the integral operating mode, to control the I-element such that the I-element makes no contribution to the control variable of the controller, and, when the process system is operated in the proportional operating mode, to control the I-element such that the I-element makes a contribution to the control variable of the controller.

As already explained in connection with the method according to the invention, the process system according to the invention offers the advantage that the control behavior can be optimized by always setting the control structure best suited to the respective operating mode, so that the best possible control performance can be achieved.

### BRIEF DESCRIPTION OF THE DRAWINGS

Further advantages and features of the invention will become apparent from the description below and from the accompanying drawings, to which reference is made and in which:

FIG. 1 schematically shows a process system according to the invention,

FIG. 2 schematically shows a further process system according to the invention,

FIG. 3 shows a pressure curve and a filling level curve in a tank of the process system according to the invention in an integral operating mode during control using a PD control structure,

FIG. 4 shows a pressure curve and a filling level curve in a tank of the process system according to the invention in an integral operating mode during control using a PID control structure,

FIG. 5 shows a pressure curve and a filling level curve in a tank of the process system according to the invention in a proportional operating mode during control using a PID control structure, and

FIG. 6 shows a pressure curve and a filling level curve in a tank of the process system according to the invention in a proportional operating mode during control using a PD control structure.

### DETAILED DESCRIPTION OF THE DRAWINGS

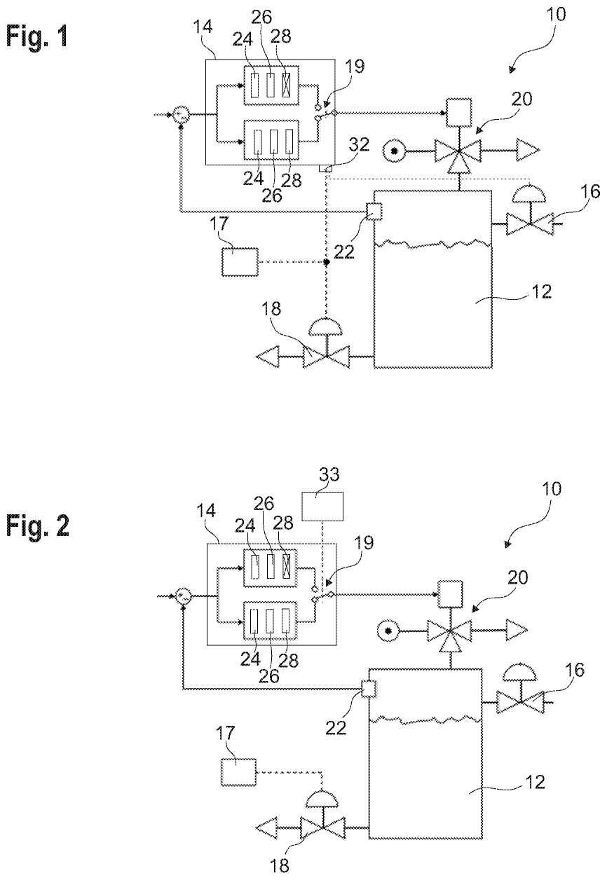

FIG. 1 schematically illustrates a process system 10.

The process system 10 comprises a tank 12 in which a fluid is contained. For example, a liquid and a gas are contained in the tank 12. In the example embodiment shown in FIG. 1, the tank 12 is a closed tank.

In addition, the process system 10 comprises a controller 14 for setting a control variable, in particular a pressure of a pressure cushion in the tank 12 or a filling level of the fluid contained in the tank 12.

The tank 12 is provided with an inlet valve 16 and a drain valve 18, which enable fluid to be withdrawn from or fluid to be supplied to the tank 12. The inlet valve 16 and the drain valve 18 may be designed as switching valves or as proportional valves.

The inlet valve 16 and the drain valve 18 are driven by a signal 17, which is schematically illustrated in FIGS. 1 and 2, in particular by means of a control unit not shown in the figures for the sake of simplicity.

Instead of two separate valves, a combined inlet and drain valve may also be provided.

In addition, a control valve 20 is provided, which serves to set the pressure of a pressure cushion in the tank 12. The control valve 20 is driven, for example, by an electric motor, pneumatically, or hydraulically.

The pressure in the tank 12 is detected by a pressure sensor 22. If the tank 12 contains liquid, the pressure is determined above the liquid level. The pressure sensor 22 is connected to the controller 14 in a signal transmitting manner.

In the process system 10 according to FIG. 1, the controller 14 is configured to drive the control valve 20 to control the pressure in the tank 12. An opening state of the control valve 20 thus represents the control variable of the controller 14.

The pressure of the pressure cushion present in the tank 12 represents the reference variable of the controller 14.

The pressure sensor 22 supplies the actual pressure in the tank 12 to the controller 14 as a feedback variable, so that the controller 14 can calculate a control deviation from the reference variable and the feedback variable, in particular the difference between the setpoint value and the actual value of the pressure prevailing in the tank 12.

The controller 14 comprises a P-element 24, a D-element 26, and an I-element 28, wherein the controller 14 is configured to control the I-element such that the I-element makes no contribution to the control variable of the controller 14, as will be described in detail below.

The process system 10 can be operated selectively in two different operating modes, namely in a first, proportional operating mode or in a second, integral operating mode.

In the first, proportional operating mode, fluid, in particular liquid, is withdrawn from the tank 12, while the reference variable, i.e., the pressure of the pressure cushion, is kept constant by the control during fluid withdrawal. The same applies accordingly when fluid is supplied.

In the second, integral operating mode, no fluid, in particular liquid, is withdrawn from the tank 12. In the second operating mode, the pressure of the pressure cushion in the tank 12 is thus controlled while maintaining a constant filling level, the pressure level in the second operating mode being changed, in particular increased or decreased.

Such operating conditions occur, for example, in so-called tank blanketing. In tank blanketing, for example, the tank 12 contains a liquid and a pressure cushion present above the liquid.

When the process system 10 is operated in the first, proportional operating mode, it is desirable for the I-element 28 to contribute to the control variable of the controller 14.

However, if the process system 10 is operated in the second, integral operating mode, the I-element 28 has a negative effect on the control performance.

According to a method for operating the process system 10, it is therefore provided that the I-element 28 can be switched off such that the I-element 28 makes no contribution to the control variable of the controller 14.

FIG. 1 illustrates this switching via a switch 19, which can switch between a first state of the controller 14, in which the I-element 28 is active, and a second state of the controller 14, in which the I-element 28 is inactive.

How this method is carried out in detail is described below.

First, it must be determined in which operating mode the process system 10 is currently operated.

In the example embodiment shown in FIG. 1, this is carried out by first determining a switching state of the inlet valve 16 and the drain valve 18, specifically by the controller 14. For this purpose, the controller 14 includes a switching input 32 which is connected in a signal transmitting manner to the inlet valve 16 and the drain valve 18.

The controller 14 thus receives a switching state and/or an opening state of the inlet valve 16 and the drain valve 18 as an input variable.

If the inlet valve 16 and/or the drain valve 18 are open, the controller 14 detects that the process system 10 is currently operated in the first, proportional operating mode.

If the inlet valve 16 and the drain valve 18 are closed, the controller 14 detects that the process system 10 is currently operated in the second, integral operating mode.

The operating mode is thus automatically detected by the controller 14.

If there is a change from the first, proportional operating mode to the second, integral operating mode, the controller 14 switches the I-element 28 off so that it no longer makes a contribution to the control variable.

Conversely, the controller 14 switches on the I-element 28 in the event of a change from the second, integral operating mode to the first, proportional operating mode, so that the I-element 28 again makes a contribution to the control variable.

Based on the detected operating mode, a binary signal is generated which represents the respective current operating mode and on the basis of which the I-element 28 of the controller 14 is controlled. Specifically, the controller 14 generates the binary signal.

When the controller 14 is switched from the first, proportional operating mode to the second, integral operating mode, or vice versa, at least one parameter for the I-element 28 is changed. In the example embodiment according to FIG. 1, this is accomplished by the binary signal.

Specifically, an adjusting time is changed to switch the I-element of the controller 14 on or off.

Upon switching from the first, proportional operating mode to the second, integral operating mode, the adjusting time is set to infinity. The I-element 28 is thus effectively switched off and therefore inactive, meaning it makes no contribution to the control variable.

Upon switching from the second, integral operating mode to the first, proportional operating mode, the I-element 28 is reactivated, which is achieved by setting the adjusting time to a defined value that is less than infinity. Values between 0.1 and 100, for example, are conceivable.

FIG. 2 schematically illustrates a further process system 10. The process system according to FIG. 2 differs from the process system 10 illustrated in FIG. 1 in that there is no signal-transmitting connection between the inlet valve 16 and the drain valve 18, and the controller 14, and consequently the controller 14 does not receive the switching state and/or the opening state of the inlet valve 16 and the drain valve 18 as an input variable.

Consequently, the respective current operating mode cannot be determined based on the switching state and/or the opening state of the inlet valve 16 and the drain valve 18.

Instead, the current operating mode is determined based on the control variable of the controller 14, which includes the opening state of the at least one control valve 20, in other words, based on the output signal of the controller 14, and additionally based on a control deviation, i.e., a difference between the actual value and the setpoint value of the pressure prevailing in the tank 12.

Here, too, the operating state is detected automatically.

For example, the controller 14 executes an algorithm, which may be stored on a processor 33 to detect the current operating mode based on the control variable of the controller and a control deviation.

For example, the controller 14 switches over if the control variable of the controller remains constant over a defined period of time and a persistent control deviation is additionally present.

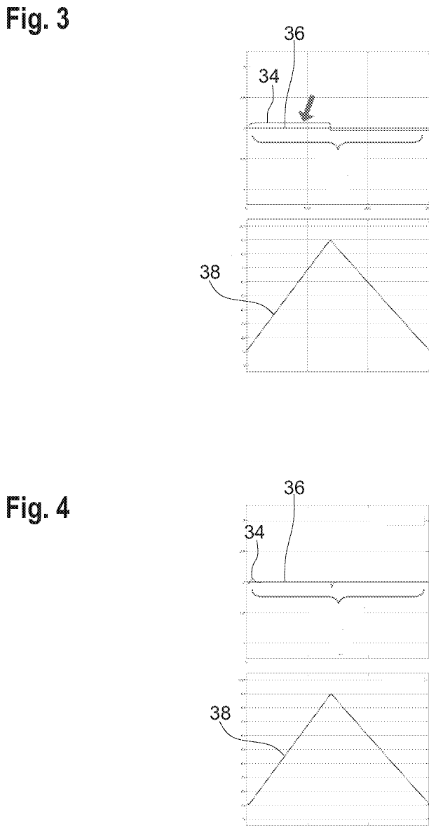

This process is explained in detail with reference to FIGS. 3 to 6.

FIGS. 3 to 6 each show a pressure curve of an actual pressure prevailing in tank 12 based on the curve 34, a desired pressure based on the curve 36, and a filling level curve in tank 12 based on the curve 38.

The pressure is respectively plotted in bar and the filling level in %.

FIGS. 3 and 4 each illustrate the first, proportional operating mode, in which fluid, in particular liquid, is withdrawn from the tank, as can be seen from the varying filling level, while the reference variable, i.e., the pressure prevailing in tank 12, is kept constant by the control.

In this state, the control valve 20 is open to keep the pressure of the pressure cushion constant despite the varying filling level.

Information regarding the opening state, in particular the degree of opening, i.e., how far the control valve 20 is open, is available to the controller 14, since the control valve 20 is driven by the controller 14 itself.

In addition, the controller 14 continuously calculates the control deviation, i.e., the difference between the actual pressure value detected by the pressure sensor 22 and the setpoint value of the pressure.

Based on the opening state of the control valve 20 and additionally based on the control deviation, a current operating mode of the process system 10 is automatically detected.

In the state illustrated in FIG. 3, the I-element 28 of the controller 14 is deactivated, which results in a sustained control deviation that is non-zero.

When the first operating mode has been determined and the optimal control structure is not set, the controller 14 switches over, that is, the I-element 28 of the controller 14 is controlled according to the detected operating mode.

In the scenario illustrated in FIG. 3, the control deviation remains constant over a longer period of time, in particular over a period of time of more than one minute.

If the scenario shown in FIG. 3 occurs, the controller 14 activates the I-element 28.

In the scenario illustrated in FIG. 4, the first operating mode also occurs. However, in the curve illustrated in FIG. 4, the I-element 28 is already activated, so that no sustained control deviation occurs. In this case, a control deviation occurs only briefly in the form of a slight overshoot upon switching between a filling mode and a withdrawal mode.

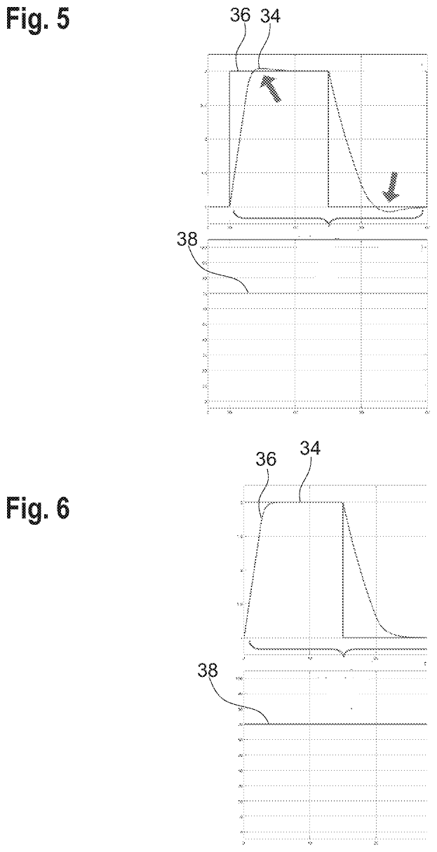

FIGS. 5 and 6 each illustrate the second, integral operating mode. In this operating mode, no fluid, in particular no liquid, is withdrawn from the tank 12, that is, the liquid filling level remains constant while the pressure is varied.

In the scenario illustrated in FIG. 5, the I-element 28 of the controller 14 is activated. This leads to a significant overshoot of the pressure level during pressure adjustment.

In this case as well, the controller 14 determines which operating mode is currently prevailing based on the opening state of the control valve 20 and the control deviation, which in the example embodiment according to FIG. 5 persists for approximately 10 to 15 seconds.

To adjust the pressure level without overshoot, the controller 14 switches off the I-element 28 once it has been detected that the second operating mode occurs.

The method and the process system were previously described in connection with the case of application of tank blanketing.

However, other cases of application are also conceivable.

For example, the method can also be used in connection with filling level control in an open tank.

In this case, the filling level serves as the reference variable for the controller 14.

In this case, the control variable of the controller 14 comprises an opening state of the inlet valve 16 and the drain valve 18 or a combined inlet and drain valve.

Based on the control variable of the controller 14 and additionally based on a control deviation, i.e., the difference between an actual filling level and a desired filling level, a current operating mode of the process system 10 can also be automatically detected in this case, and the I-element 28 of the controller 14 is controlled according to the detected operating mode.

The first operating mode is, for example, a proportional operating mode in which the filling level in the tank 12 is kept constant during fluid withdrawal and/or fluid supply.

The second operating mode is, for example, an integral operating mode in which the filling level is kept constant without any fluid being withdrawn.

1. A method for operating a process system for pressure cushion control or filling level control in a tank in which a fluid, for example a liquid and/or a gas, is contained, comprising a controller for setting a reference variable, wherein the controller includes at least a P-element, via which a proportional component of a control variable of the controller is set, and an I-element, via which an integral component of the control variable of the controller is set,
wherein the process system is operated selectively in a first, proportional operating mode or in a second, integral operating mode,
wherein the I-element of the controller makes no contribution to the control variable of the controller when the process system is operated in the second, integral operating mode, and the I-element of the controller makes a contribution to the control variable of the controller when the process system is operated in the first, proportional operating mode.

2. The method according to claim 1, wherein the reference variable is a pressure of a pressure cushion in the tank or a filling level of a fluid contained in the tank.

3. The method according to claim 1, wherein, in the first, proportional operating mode, fluid is withdrawn from the tank or supplied to the tank while the reference variable is kept constant by the control, and in the second, integral operating mode, no withdrawal from the tank takes place.

4. The method according to claim 1, wherein, in the first operating mode, the pressure of the pressure cushion in the tank is kept constant by the control during fluid withdrawal, and in the second operating mode, the pressure of the pressure cushion in the tank is controlled at a constant filling level.

5. The method according to claim 4, wherein a pressure level is changed in the second operating mode.

6. The method according to claim 1, wherein an inlet valve and a drain valve are provided on the tank, or a combined inlet and drain valve is provided for withdrawing fluid from the tank or supplying fluid to the tank, wherein the current operating mode is determined based on a switching state and/or opening state of the at least one valve and the I-element of the controller is driven based on the determined operating mode.

7. The method according to claim 6, wherein the controller receives a switching state and/or an opening state of the inlet valve and the drain valve or the combined inlet and drain valve as an input variable.

8. The method according to claim 6, wherein, based on the detected operating mode, a binary signal is generated which represents the respective current operating mode and based on which the I-element of the controller is controlled.

9. The method according to claim 1, wherein the tank is a closed tank and the pressure of the pressure cushion in the tank is set by means of at least one control valve, wherein based on the control variable of the controller, which comprises an opening state of the at least one control valve, and additionally based on a control deviation, a current operating mode of the process system is automatically detected, and the I-element of the controller is controlled according to the detected operating mode.

10. The method according to claim 6, wherein a filling level in the tank is set, wherein, based on the control variable of the controller, which comprises the opening state of the inlet valve and the drain valve or the combined inlet and drain valve, and additionally based on a control deviation, a current operating mode of the process system is automatically detected, and the I-element of the controller is controlled according to the detected operating mode.

11. The method according to claim 9, wherein the controller switches over when the control variable of the controller remains constant over a defined period of time and, in addition, a persistent control deviation is present.

12. The method according to claim 1, wherein an actual value of the pressure in the tank is detected by means of a pressure sensor and a control deviation is calculated as a difference between the actual value and a setpoint value of the pressure.

13. The method according to claim 1, wherein the controller executes an algorithm to detect a current operating mode based on the control variable of the controller and a control deviation.

14. The method according to claim 1, wherein at least one parameter for the I-element is changed when the controller is switched from the first, proportional operating mode to the second, integral operating mode, or vice versa.

15. A process system, comprising a tank in which a fluid, for example a liquid and/or a gas, is contained, and a controller for setting a reference variable, wherein the controller includes at least a P-element, via which a proportional component of a control variable of the controller is set, and an I-element, via which an integral component of the control variable of the controller is set,
wherein the process system is adapted to be operated selectively in a first, proportional operating mode or in a second, integral operating mode,
wherein the controller is configured to detect whether the process system is operated in the proportional operating mode or in the integral operating mode, and, when the process system is operated in the integral operating mode, to control the I-element such that the I-element makes no contribution to the control variable of the controller, and, when the process system is operated in the proportional operating mode, to control the I-element such that the I-element makes a contribution to the control variable of the controller.

16. The process system according to claim 15, wherein the reference variable is a pressure of a pressure cushion in the tank or a filling level of a fluid contained in the tank.
